(19) United States
(12) Patent Application Publication
(10) Pub. No.: US 2010/0112249 A1
(43) Pub. Date: May 6, 2010

(54) SIGN POST COMPRISING COMPOSITE MATERIAL

(76) Inventor: Gerard S. Boyce, Ruddington (GB)

Correspondence Address: 3M INNOVATIVE PROPERTIES COMPANY, PO BOX 33427, ST. PAUL, MN, 55133-3427, US

(21) Appl. No.: 12/529,304

(22) PCT Filed: Mar. 4, 2008
(86) PCT No.: PCT/US08/55784

§ 371 Date: Nov. 18, 2009

(30) Foreign Application Priority Data
Apr. 13, 2007 (GB) 0707155.8

(51) Int. Cl. E01F 9/011; B29C 70/52; B29D 23/00; B32B 1/08; B32B 5/12; B32B 27/04

(52) U.S. Cl. 428/34.5; 264/171.12; 428/36.4; 428/36.1

(57) ABSTRACT

There is provided a tubular support comprising a first composite layer of resin and longitudinal arranged fibers (66, 98) having on each of its opposite major sides a further composite layer (64, 70) comprising resin, transverse fibers at an angle of between 10 and 80° relative to the longitudinal axis of said tubular support and traverse fibers at an angle of between −10 and −80° relative to the longitudinal axis of said tubular support. The method for producing this tubular support is also disclosed.

### FIELD OF THE INVENTION

The present invention relates to a tubular support, that is based on a composite material. In particular, the invention relates to tubular support posts that can be placed on the side of a street or road for example to hold signs, including traffic signs, lighting, as well as commercial signs.

### BACKGROUND OF THE INVENTION

The vast majority of tubular support posts such as sign posts used along streets, roads and motorways are steel tubular supports. The steel posts are used in various sizes depending on the sign load and application conditions. Typically steel posts are available in standardized sizes and shapes and hence the installation aids to be used with these standard sizes is standardized as well. Steel posts withstand weathering for up to 15 years before they require replacement.

One problem with steel sign posts is that during a vehicle collision, the steel post will generally not give way upon impact. Because the post remains rigid close to ground level, it can penetrate the vehicle. In many cases, the vehicle is already out of control when it hits the post, so can hit it at any angle. This type of impact can result in fatalities and serious injuries to the vehicle occupants, particularly if the impact is side-on. Hence, there exists a desire to find alternative posts that have less potential for causing vehicle damage and less potential for injury. National governments and authorities are continuously attempting to enhance the road safety and increase safety of the road infrastructure. In particular, some authorities have developed passive safety requirements for sign posts used on the side of streets. An example thereof is European standard EN12767 which classifies sign posts in categories depending on energy on impact at a particular vehicle speed.

EN 12767 specifies requirements for passive safety and defines levels in passive safety terms intended to reduce the severity of injury to occupants of vehicles in impact with roadside structures. According to regulations governing standards, the national standards organizations of 19 EU countries are bound to implement this standard. The levels of passive safety are defined in terms of High Energy (HE), Low Energy (LE) and Non-Energy (NE), which are determined by measuring the speed of the vehicle at a point beyond impact and comparing with the defined impact speed. The difference in these speeds relates to the energy of impact. Energy absorbing support structures may slow the vehicle considerably and thus the risk of secondary accidents with structures, trees, pedestrians and other road users can be reduced. Non-energy absorbing support structures may provide a lower primary risk of injury caused by the initial impact with the said support structure than energy absorbing support structures. Occupant risk levels are also defined on a scale of 1 to 4, in order of increasing safety. Levels 1-3 for a particular speed class require a test at 35 km/hr and at one of 50, 70 or 100 km/hr and level 4 requires only to be tested at the class speed.

It would now be desirable to develop a tubular support that can be used as a sign post in traffic and which tubular support meets various national standards for passive safety. For example, it should have a non-energy (NE) or a low energy (LE) classification under EN12767 at a speed of impact of 50, 70 or 100km/hr. An element in achieving this classification is the energy absorbed by the support, when impacted, which should be minimized, i.e. the support should be designed to give way upon impact. Of course it would be desirable to develop such a tubular support in such a way that other performance requirements typically imposed on sign posts can be met as well. In particular, the support should have appropriate stiffness and strength to hold a sign under the expected design loadings resulting from wind pressure on the sign and wind buffeting. It would be desirable to develop posts meeting the requirements of EN12899 and corresponding standards in other countries. It is interesting to note here that typically the desire to have NE or LE classification under EN12767 and the strength and stiffness requirements under EN12899 are competing properties.

For example, in U.S. Pat. No. 4,939,037 there is described a composite sign post for replacing the steel post. The sign post disclosed therein comprises longitudinal and/or transverse arranged fibers in a resin matrix. Typically used and disclosed fibers are glass fibers. However, the problem with a composite sign post based on glass fibers as disclosed in this US patent is that the stiffness performance of such a post will be at the lower end of what is required. While this could be solved by increasing the wall thickness of the post, this would also imply that the passive safety features are reduced, hence illustrating the competition between strength and passive safety. Alternatively, it could be contemplated to increase the diameter of the post but this would likely mean that the size would fall outside the standardized ranges of steel posts with the consequence that installation equipment adapted for use with steel posts cannot be used. Additionally, the size of such a post might contribute to road hazards by unduly obstructing the view of road users, and become aesthetically displeasing. This would likely lead to its rejection by highways authorities.

U.S. Pat. No. 3,853,314 describes tubular support posts based on carbon fibers. The fibers are arranged in plies that are overlying each other with each individual ply alternating at an angle + and −α relative to the longitudinal axis of the tubular support post. The angle is typically between 30 and 60. Accordingly, one ply would have an angle of +α and the next would have an angle of −α. The number of plies may vary between 2 and 30.

### SUMMARY OF THE INVENTION

It would be desirable to find an alternative composite sign post that combines high strength and good passive safety, preferably at or in the standard steel post size ranges, which for example for circular cross section posts in the UK are 88.9 mm, 114.3 mm and 139.7 mm. In particular it would be desirable to obtain a NE or LE classified composite sign post meeting strength requirements similar to or exceeding those of a steel post of the same dimensions or of a steel post with a one (standard) size down. Hence existing installation equipment should be useable with the composite sign post. It would furthermore be a desired feature that the composite post can be manufactured in an easy and convenient way at minimal cost.

In accordance with one aspect of the present invention there is provided a tubular support comprising a first composite layer of resin and longitudinal arranged fibers having on each of its opposite major sides a further composite layer comprising resin, transverse fibers at an angle of between 10 and 80° relative to the longitudinal axis of said tubular support and transverse fibers at an angle of between −10 and −80° relative to the longitudinal axis of said tubular support.

In accordance with a further aspect of the present invention there is provided a method of making a tubular support as defined above comprising (i) providing a tubular arrangement of fibers comprising a layer of longitudinal fibers with on each of its opposite major sides being arranged a layer of transverse fibers at an angle of between 10 and 80° relative to the longitudinal axis of the tubular arrangement of fibers and transverse fibers at an angle of between −10 and −80° relative to the longitudinal axis of the tubular arrangement of fibers, (ii) impregnating the tubular fiber arrangement with resin and (iii) pulling the tubular fiber arrangement through a heated die to provide a desired shape to the tubular support.

It has been found that tubular supports can be used as supports for supporting signs placed along the side of a road. The term ‘road’ as used in connection with the present invention is to be understood as including any road designed or intended to be used by vehicles, in particular motor vehicles. Roads include by way of example streets, cycling paths, motorways, airport concourses, freeways and highways.

### DETAILED DESCRIPTION OF THE PREFERRED EMBODIMENTS

The tubular supports according to the invention typically meet the strength requirements while providing good to excellent passive safety including LE or NE classifications under EN12767. Typically, the tubular supports should have a good to an excellent flexural modulus that results in a bending moment capacity at deflection as measured under EN12899 that is comparable to that of steel posts of similar dimensions. Hence, the installation equipment typically used with steel posts is useable with the composite tubular supports according to the invention. Furthermore, typically the composite tubular supports can be produced in an easy and convenient way using pultrusion and are cost effective.

The tubular support in accordance with the present invention comprises a composite layer of resin and longitudinal arranged fibers. On each of its opposite major sides a further composite layer is provided. The further composite layers each comprise resin, transverse fibers at an angle of between 10 and 80° relative to the longitudinal axis of the tubular support and transverse fibers at an angle of between −10 and −80° relative to the longitudinal axis of the tubular support. In a particular embodiment, the transverse fibers are arranged at an angle between 30 and 60° and −30 and −60° respectively. In a yet further embodiment, a third set of transverse fiber rovings may be included in each of the two further composite layers. This third set of transverse fiber rovings will be included at an angle different from the angle of the other two sets of transverse fiber rovings, for example at an angle close to 0°, for example between −5 and 5°.

In a particular embodiment, the transverse fiber rovings of the further composite layers are included in the tubular support as a biaxial (in case of two sets of transverse fiber rovings) or as a triaxial mat (in case of three sets of transverse fiber rovings). Preferably, the mat will comprise of woven fiber rovings that are stitched together to maximize dimensional stability and to reduce fraying. Typically, woven mats can be used that have a fabric nominal weight of 200 to 2000 g/m², for example 300 to 1500 g/m².

Fibers that may be used for the transverse fibers include any of the fibers mentioned below for the longitudinal fibers. Particularly preferred are glass fiber rovings including E-glass, C-glass, R-glass, S-glass, T-glass, A-glass as well as ECR glass fibers.

The fiber rovings of the transverse fibers consist of a bundle of fiber filaments. The transverse fibers typically have a filament diameter between 1 and 40 microns, for example between 5 and 25 microns. Transverse fiber rovings typically have a TEX value of between 100 and 4800, for example between 1200 and 4800. The TEX value is an indication of the linear mass of the fiber filaments in a roving, expressed in g/km. For example, a TEX value of 4800 would mean the linear mass of the roving is approximately 4800 g/km. The transverse fiber rovings typically are comprised in the tubular support in an amount of 10 to 40% by weight of the total weight of the tubular support, for example between 12 and 30% by weight of the total weight of the tubular support. The use of the composite layers of transverse fibers on both opposite major sides of the composite layer of longitudinal fibers typically improves the strength of the tubular support. For example transverse stiffness and the torsional rigidity are generally increased. Accordingly, the tubular support will be particularly useful for use as a post for holding a sign. Thus, the strength of the post can be improved such that a post meeting the required strength under various conditions of loading can be obtained or designed with dimensions that are close to the external dimensions of a steel post designed for use under the same loading conditions. This then allows the use of typical and standard installation equipment normally used in conjunction with steel posts.

In a particular embodiment in connection with the present invention a composite layer of resin and randomly chopped fibers is included between each of the composite layers of transverse fibers and the composite layer of longitudinal fibers. The use of these additional composite layers of randomly chopped fibers may offer the advantages of maximising the load transfer and increasing the interlaminar shear strength between the composite layer with longitudinally arranged fibers and the layer of transversely arranged fibers. In a particularly preferred embodiment, the randomly chopped fibers are included by stitching them to a woven mat of the transverse fibers. Suitable fibers for use as chopped fibers include any of the fibers mentioned above but generally include chopped glass fibers. The length of the chopped fibers may vary widely but is typically between 1 and 260 mm, for example between 25 and 100 mm. The diameter of the chopped fibers may also vary widely but is typically between 1 and 40 microns or between 5 and 25 microns.

Generally the layer of chopped fibers has a weight between 20 and 600 g/m², for example between 100 and 300 g/m². The amount of chopped fibers in the tubular support is typically between 1 and 10% by weight of the total weight of the tubular support, for example between 3 and 7% by weight.

The composite layers of transverse fibers are arranged on both opposite major sides of a composite layer comprising longitudinal fibers. In accordance with one embodiment of the invention, a single type of longitudinal fibers may be used such as for example any of the glass fibers mentioned below, aramid fibers or carbon fibers. According to another embodiment, a mixture of different longitudinal fibers may be used such as for example a mixture of glass fiber rovings and carbon fiber rovings.

In accordance with a particularly preferred embodiment of the present invention, the tubular support comprises a composite layer of resin and longitudinal arranged first and second fibers. The second fibers typically have a Tensile modulus measured according to ASTM Standard D4018-99 (2004) that is larger than the Tensile modulus of the first fibers.

Typically, the second fibers have a Tensile modulus that is at least 1.5 times the Tensile modulus of the first fibers. For example, according to one embodiment, the Tensile modulus of the second fibers is between 1.5 and 10 times the Tensile modulus of the first fibers, alternatively between 2 and 8 times the Tensile modulus of the first fibers or between 3 and 6 times the Tensile modulus of the first fibers.

According to a particular embodiment, the Tensile modulus of the first fibers is between 50 and 100 GPa, for example between 60 and 90 GPa. In another embodiment, the Tensile modulus of the first fibers is between 65 and 80 GPa. According to a particular embodiment, the Tensile modulus of the second fibers is between 200 and 800 GPa, for example between 150 and 500 GPa. In another embodiment, the Tensile modulus of the second fibers is between 200 and 400 GPa.

Examples of fibers that can be used as first fibers include glass fibers such as E-glass, C-glass, R-glass, S-glass, T-glass, A-glass as well as ECR glass fibers. Basalt may also be used as first fibers. Still further fibers that may be contemplated for use as first fibers include polyester fibers, polyethylene fibers and natural fibers such as reconstituted wood.

Examples of fibers that can be used as second fibers include in particular carbon fibers. Such carbons fibers are available in a range of moduli, e.g. high modulus carbon with a Tensile modulus of 393 GPa and Ultra high modulus carbon with a Tensile modulus of 724 GPa. In one embodiment, carbon fibers are used that are obtained by pyrolysis or a process of oxidation, carbonization and graphitization. For example pyrolyzed carbonaceous fibers that may be used in this invention may be formed in accordance with a variety of techniques known in the art. For instance, organic polymeric fibrous materials which are capable of undergoing thermal stabilization initially may be stabilized by treatment in an appropriate atmosphere at a moderate temperature (e.g., 200° to 400° C.), and subsequently heated in an inert atmosphere to a more highly elevated temperature, e.g., 1500° to 2000° C., or more, until a pyrolyzed carbonaceous fibrous material containing a desired amount of carbon by weight is obtained. Typically fibers will be desired that have at least about 90 per cent carbon by weight. The higher the temperature (e.g., within the range of about 2000° to 3100° C.) the more perfect the graphitic structure produced within the same.

The exact temperature and atmosphere utilized during the initial stabilization of an organic polymeric fibrous material commonly vary with the composition of the precursor as will be apparent to those skilled in the art. During the subsequent carbonization reaction elements present in the fibrous material other than carbon (e.g., oxygen and hydrogen) are substantially expelled. Suitable organic polymeric fibrous materials from which the fibrous material capable of undergoing carbonization may be derived include an acrylic polymer, a cellulosic polymer, a polyamide, a polybenzimidazole, polyvinyl alcohol, etc. Acrylic polymeric materials particularly are suited for use as precursors in the formation of graphitic carbonaceous fibrous materials. Illustrative examples of suitable cellulosic materials include the natural and regenerated forms of cellulose, e.g., rayon. Illustrative examples of suitable polyamide materials include the aromatic polyamides, such as nylon 6T, which is formed by the condensation of hexamethylenediamine and terephthalic acid. An illustrative example of a suitable polybenzimidazole is poly-2,2′-m-phenylene-5,5′-bibenzimidazole.

Other fibers that can be used as second fibers include alumina, alumina-zirconia ceramic fibers, stainless steel, and aromatic polyamide fibers including for example KEVLAR™49 fibers available from Dupont.

Typically the first and second fibers are used as fiber rovings, i.e. they consist of a bundle of fiber filaments. First fibers typically have a filament diameter between 1 and 40 microns, for example between 5 and 25 microns. First fiber rovings typically have a TEX value of between 100 and 4800, for example between 1200 and 4800. Commercially available glass fiber rovings that can be used include E-glass rovings available form Saint-Gobain Vetrotex under the brand RO99.

Second fibers typically have a filament diameter between 1 and 12 microns, for example between 5 and 8 microns. Second fiber rovings typically have a TEX value of between 50 and 4000, for example between 800 and 3800. Commercially available carbon fiber rovings that can be used include GRAFIL™ carbon rovings such as GRAFIL™ 34-600WD available from Grafil Inc and PANEX™ 35 available from Zoltec Companies Inc.

The resin for use in the composite layers as a matrix for the longitudinal fibers as well as a matrix for the transverse fibers includes crosslinked resins such as thermoset resins as well as thermoplastic resins. Illustrative examples of suitable thermosetting resins for use in production of the tubular member include epoxy resins, thermosetting polyesters including vinylester resins, phenolics, polyimides, polybenzimidazoles, etc.. Particularly suitable thermosetting resins are vinylester resins and epoxy resins. Thermoplastic resins may be melted to impregnate the fibers and set upon cooling, or formed in situ by a catalyzed addition reaction, similarly to thermosetting resins. Illustrative examples of thermoplastic resinous materials include polyamides, polyoxymethylenes, polyolefins (e.g., polyethylene and polypropylene), thermoplastic polyesters or polyurethanes, etc.

The epoxy resin utilized as the resinous matrix material may be prepared by the condensation of bisphenol A (4,4′ isopropylidene diphenol) and epichlorohydrin. Also, other polyols, such as aliphatic glycols and novolak resins (e.g., phenol-formaldehyde resins), acids, or other active hydrogen containing compounds may be reacted with epichlorohydrin for the production of epoxy resins suitable for use as the resinous matrix material. Epoxy resins are preferably selected which possess or can be modified to possess the requisite flow characteristics prior to curing.

Numerous reactive diluents or modifiers which are capable of increasing the flow properties of uncured epoxy resins are well known and include butyl glycidyl ether, higher molecular weight aliphatic and cycloaliphatic mono-glycidyl ethers, styrene oxide, aliphatic and cycloaliphatic diglycidyl ethers, and mixtures of the above.

A variety of epoxy resin curing agents may be employed in conjunction with the epoxy resin. The curing or hardening of the epoxy resin typically involves further reaction of the epoxy or hydroxyl groups to cause molecular chain growth and cross-linking The term “curing agent” as used herein is accordingly defined to include the various hardeners of the co-reactant type. Illustrative classes of known epoxy curing agents which may be utilized include aliphatic and aromatic amines, polyamides, tertiary amines, amine adducts, acid anhydrides, acids, aldehyde condensation products, and Lewis acid type catalysts, such as boron trifluoride. The preferred epoxy curing agents for use with the epoxy resin are acid anhydrides (e.g., hexahydrophthalic acid and methylbicyclo[2.2.1]heptene-2,2-dicarboxylic anhydride isomers marketed under the designation Nadic Methyl Anhydride by the Allied Chemical Company), and aromatic amines (e.g., meta-phenylene diamine and dimethylaniline).

Particularly suitable resins for use in connection with this invention include thermoset resins based on vinylesters. An example of vinylester that may be used includes a vinylester based on the condensation of bisphenol A and epichlorohydrin having the following formula:

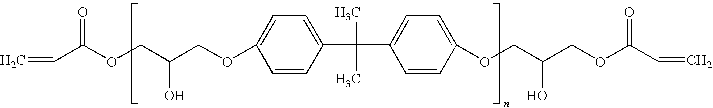

Wherein n is 1 or more, or typically in the range 1 to 5, or preferably 1 or 2.

Typically one or more thermal initiators are mixed with the vinylester to initiate curing of the vinylester resin upon heat activation. Suitable initiators or catalysts include various peroxide curing or cross-linking agents such as bis(4-tert-butyl cyclohexyl)-peroxydicarbonate, tert-butylperoxyneodecanoate, tent-Butyl peroxy-2-ethylhexanoate, 2,5-dimethyl-2,5-bis(2-ethylhexanoylperoxy) hexane, tert-amylperoxy-2-ethylhexanoate, 1,1-di-(t-butylperoxy)-3,3,5-trimethylcyclohexane, tert-butylperoxybenzoate, and di-benzoyl peroxide, which may be used alone or in admixture, and/or bulked with a plasticizer such as dicyclohexylphthalate. Those that activate at a lower temperature may be used as initiators, and may generate heat that leads to activation of other agents in the mixture. A fuller cross-linking is achieved by those agents that operate at a higher temperature, contributing to the rigidity of the physical structure.

The total amount of longitudinal fibers in the composite layer may vary widely depending on the application and load requirements imposed on the tubular support when used as tubular support post. Typically the total amount of longitudinal fibers is between 50 and 90% by weight based on the total weight of the tubular support. In one embodiment the amount is between 60 and 90. In yet another embodiment, the amount is between 70 and 90. When a mixture of first and second longitudinal fibers is used, the latter are preferably concentrated in discrete domains across the circumference of the tubular support and the amount of first fibers will then generally be larger then the amount of second fibers. For example, in such an embodiment the amount of second fibers (expressed as number of fibers) is between 3 and 45% of the amount of first and second fibers, for example between 5 and 40% or between 8 and 35% or between 10 and 30%. Generally a minimum amount of second fibers is included to obtain the desired performance level. Including more second fibers may further improve the performance but typically goes to the cost of the supportas second fibers tend to be more expensive than first fibers.

As already mentioned, in a particularly preferred embodiment the first longitudinal fibers are distributed in a generally uniform way in the composite layer around the circumference of the tubular support while the second fibers are concentrated in discrete domains. By ‘generally uniform’ is meant that any two arbitrary sections of the tubular support taken along the circumference of the tubular support show a similar distribution of first longitudinal fibers except for a possible interruption by second fiber domains as described below in accordance with a particular embodiment. Accordingly, except for possible second fiber domains, the composite layer would appear as a continuous or generally continuous layer. Arrangements described in this patent specification as “longitudinal”, may include those in a slightly helical path, where the pitch of the helix defined as an angle between the axis of the supportand the direction of the roving, can be up to 10 degrees.

The second longitudinal fibers are preferably located or placed in discrete domains distributed along the circumference of the tubular support. By discrete domains is meant that the second fiber rovings are clustered in particular domains along the circumference. Typically these domains would be generally evenly distributed along the circumference although this may not be required in all applications. In one embodiment, the second fibers are distributed in domains located within the composite layer defined by said first fibers and resin. In other words, in this embodiment, the domains of second fibers may interrupt the continuous phase defined by first fibers. Within the composite layer, the domains of second fibers may be located radially outermost whereby the domains only appear towards the radially outermost part of the composite layer. In another embodiment, the domains of second fibers may be placed radially innermost and in yet another embodiment, the domains may appear on both the innermost and outermost part of the composite layer.

In a still further embodiment, the clusters or domains of second longitudinal fiber rovings may be arranged along the circumference of the tubular support in an adjacent layer, in particular a layer contiguous to the composite layer of first longitudinal fibers. Typically such a contiguous layer will be located on the radially outermost side of the composite layer of first longitudinal fibers. Such an arrangement may be achieved through the use of a woven mat having longitudinal second fiber rovings such as for example carbon rovings.

The tubular support may further include a veil as outermost and innermost layer to impart a desired look and feel to it, and enhance durability and wear resistance. The tubular support according to the present invention is elongated and has a hollow core. The cross-section of the tubular support may comprise any suitable shape including circular, oval, square, rectangular or combinations thereof such as semi-circular combined with a rectangular portion. The cross-section may also vary along the tubular support and likewise can the dimensions thereof vary along the tubular support. For example, in one embodiment, the tubular support may taper along its length. The skilled person using constructions of supportdescribed in this patent specification will be able to select a thickness of supportthat provides for the chosen diameter the required stiffness to comply with standards, whilst optimizing the strength and impact resistance through choice of materials making up the construction to achieve the required passive safety.

The tubular support according to the invention is particularly suited as a tubular support for the support of lighting fixtures, traffic control indicia, utility lines, and the like. Such tubular supports are typically arranged alongside of a road. The tubular support according to the invention can exhibit high strength characteristics under static conditions making it suitable for use to support traffic signs or any other type of signs, cameras and the like that are being placed on the side of a road. A tubular support for use alongside of a road may be installed at the side of the road by securing its lower end in a substantially vertical position in a mounting means adjacent a road. The mounting means is typically structured so that it exhibits no substantial impediment to the movement of a vehicle. For instance, the mounting means may comprise a socket of concrete or other durable material which appreciably does not extend above ground level and which engages the lower end of the tubular member.

When a vehicle which inadvertently has left the road strikes the tubular support, the possibility of bodily injury and vehicular property damage is minimized. The tubular support readily undergoes catastrophic rupture when struck by a moving vehicle because of its low impact strength. Little energy is consumed upon impact and the rate of movement of the vehicle may be altered only moderately.

The tubular support according to the present invention may offer significant advantages. Unlike wooden or metallic poles, the supports of the present invention readily may be handled and moved without resorting to complex equipment, and are of lighter weight. The combination of properties exhibited by the tubular support enables the support reliably to withstand normal environmental conditions such as wind, precipitation, etc. Upon impact, the tubular member easily ruptures. The tubular support according to the present invention may be made by pull-winding, filament-winding, vacuum infusion, or a variety of other processes.

However, it is preferably produced by pultrusion. This process is relatively cheap, produces continuous lengths of support and provides a support with reproducible straight and parallel sides. Accordingly, a method of making the support comprises (i) providing a tubular arrangement of fibers comprising a layer of longitudinal fibers with on each of its opposite major sides being arranged a layer of transverse fibers at an angle of between 10 and 80° relative to the longitudinal axis of the tubular arrangement of fibers and transverse fibers at an angle of between −10 and −80° relative to the longitudinal axis of the tubular arrangement of fibers, (ii) impregnating the tubular fiber arrangement with resin and (iii) pulling the tubular fiber arrangement through a die to provide a desired shape to the tubular support. The die is typically heated, in particular when the resin used is a thermosetting resin. However, heating of the die will not be necessary when a thermoplastic resin is used. The fibers are typically impregnated by pulling the fibers through a resin bath that includes the resin composition. Alternatively, the resin composition may be injected into the die in order to impregnate the first and second fibers. In a preferred embodiment, the resin composition used for the impregnation is a thermoset resin and the resin is cured or caused to cure in the die by heating the die. The die, for example a heated die, may include a die with a fixed internal diameter and a centrally cantilevered mandrel of lesser external diameter, between which the tubular support is formed.

In a particular embodiment, the layers of transverse fibers in the tubular fiber arrangement can be conveniently achieved by providing a woven mat of the transverse fiber rovings, for example a biaxial mat or triaxial mat, supplying a pair of mats through angled vertical slots in a die as described later so as to form a cylindrical layer e.g. by pulling around a mandrel. The longitudinal fibers are then arranged around this cylindrical mat layer. The second layer of transverse fibers can then be obtained by supplying a further pair of mats by pulling them through a further die via diagonally arranged transverse slots as described later thereby forming a cylindrical mat layer around the longitudinal fibers. This whole arrangement may then be pulled through the die. Also, this arrangement will be impregnated in a resin bath as described above or may alternatively be impregnated with resin by injection of resin in the die. If layers of chopped fibers are to be included as well, it will be preferred to stitch bond them to the mat of transverse fibers.

According to a particularly preferred embodiment described above the tubular support would include first and second longitudinal fibers whereby the latter are concentrated in discrete domains. In order to achieve this in the above described pultrusion method, a series of first and second fibers are arranged and pulled into the die such that in the resulting tubular support, the second fibers will be concentrated in discrete domains along the circumference of the tubular support. The first fibers are typically arranged such that they will be distributed generally uniformly along the circumference of the tubular support as already described above.

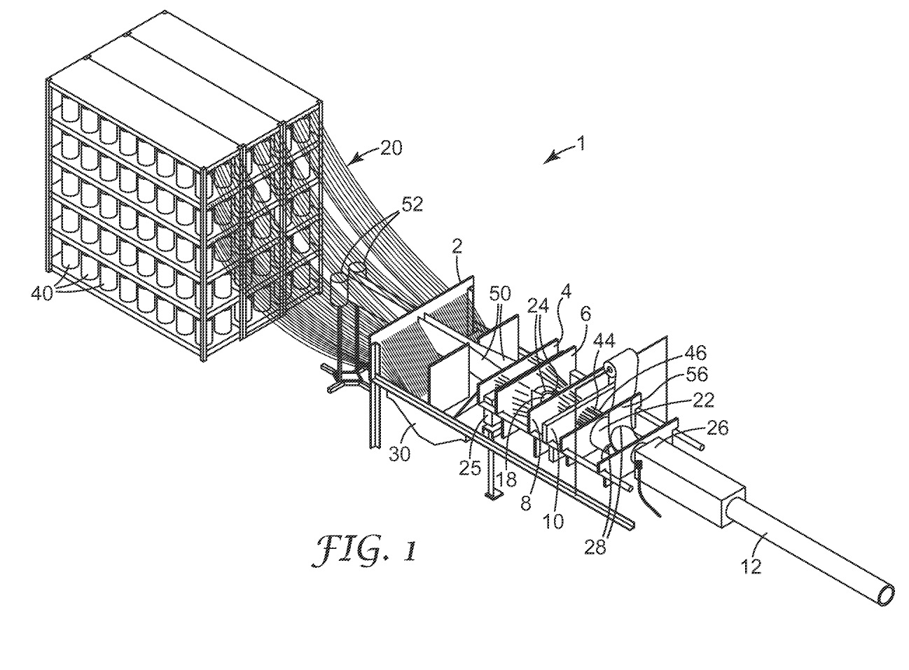

In FIG. 1, an apparatus and method of making a tubular support according to a particular embodiment of the present invention is illustrated. As shown in FIG. 1, a pair of mats (50) provided from rolls (52) are fed through pairs of vertical slots in an anterior carding frame (2) and then through the first and second carding frames (2,4) and directed through angled vertical slots (24) in a die (18) to the interior thereof, for example a plastic die such as a polypropylene die, positioned between the second and third carding frames (4,6) where they are wrapped around the cantilevered mandrel which provides the internal shape of the tube. The cantilevered mandrel is supported on a rigid mounting (25) and extends from the mounting point all the way through to the exit end of the die (26). Generally the width of the mats will be such that enough to overlap occurs between the mats, thereby forming a cylindrical mat layer. This cylindrical layer will form a mat of transverse fibers on the inside of the final tubular support.

First and second fiber rovings (20) are fed from racks of bobbins (or creels) (40) through holes in the anterior carding frame (2) positioned to direct them through the resin composition bath (30), then while retaining a soaking of resin from the bath through a succession of carding frames (4,6,8,10) with holes to arrange the rovings into the desired three concentric cylindrical arrays to form the longitudinal reinforcement of the tubular support. The inner two cylindrical arrays are of first fiber rovings, and the outermost cylindrical array comprises a combination of first and second fiber rovings. Between the second and third carding frames (6,8), first fiber rovings are guided over the cylindrical layer transverse fiber mat. The next array of first fiber rovings is added between the third and fourth carding frames (8,10). After the fourth carding frame (10) the remaining combination of second fiber rovings (44) and first fiber rovings (46) is guided into the entrance of a pre-forming die (22). Any excess resin on the rovings may be squeezed out during entry into the pre-forming die. A second pair of mats of transverse fibers (upper mat, 56) provided from rolls (upper roll, 54) are fed through a pair of angled transverse slots (28) in the pre-forming die (22) to provide an overlapping cylindrical wrap of mat of transverse fibers around the outermost rovings. The entire composite construction may then be cured by passing into a metal die (26) heated near its entrance. The die may be heated to any desired or required temperature to cause setting of the resin composition. Typically, the temperature for curing will be between 100° C. and 200° C. Following curing, the resulting tubular support can be drawn from the die using grippers.

Varying combinations of mandrel external diameter and/or shape, die internal diameter and/or shape, number and width of internal and external mats and the total number of first and second fiber rovings provide flexibility in the shape, diameter and wall thickness of the tubular post to be produced.

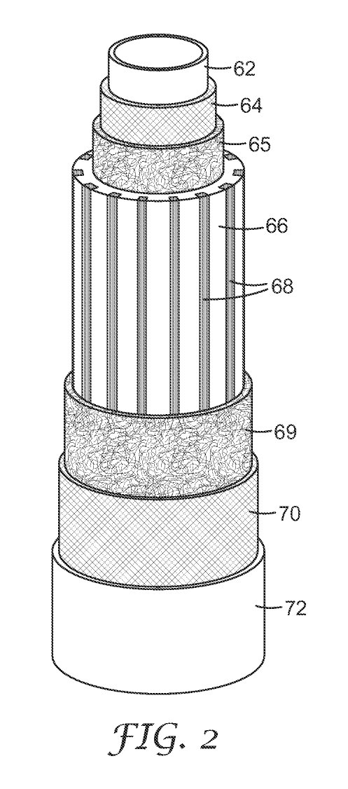

FIG. 2 illustrates an embodiment of a tubular support according to the present invention as it may result from the process described above in connection with FIG. 1. The tubular support of FIG. 2 consists of the following layers starting from the inside and working outwards: inner surface veil and resin layer (62), inner biaxial mat (64) with random chop strand mat (65), longitudinal first fiber rovings (66), longitudinal second fiber rovings (68), random chop strand mat (69) with outer biaxial mat (70), outer surface veil and resin layer (72). The inner biaxial mat and chop strand mat layer (64,65) is formed from mats (50). The outer biaxial mat and chop strand mat layer (70,69) is formed from mats (56). As can be seen from FIG. 2, the second fiber rovings are concentrated in domains that are distributed along the circumference of the tubular support. These domains are generally distributed in a regular way along the circumference.

The invention will now be further illustrated with reference to the examples in the following experimental section without however the intention to limit the invention thereto.

Experimental Section

Materials

a. Fibers

E-glass rovings—4800 TEX roving has 4800 filaments of 24 micron diameter, available from Saint-Gobain Vetrotex UK Ltd., Unit 2, Thames Park, Lester Way, Wallingford, Oxfordshire, OX10 9TA, UK. The tensile modulus of the filaments is 69 Gpa.

Carbon rovings (otherwise known as tows)—PANEX 35(50k Tex) available from Zoltec

Companies Inc., 3101 McKelvey Road, St. Louis, Mo., M063044, USA. The diameter of the filaments is 7.2 microns and the tensile modulus of the filaments is 242 Gpa.

b. Mats

Mats comprising ±45° Biaxial E-glass (600 g/m²), the E-glass being the same filament as used in the rovings, and having Random orientation chop mat (225 g/m²), the chopped fibers being E-glass of length 25-75 mm and diameter 24 microns, stitched onto one side of the mat.

c. Polymers

Resin:

ALTAC 580 vinyl ester thermoset resin, available commercially from DSM Composite Resins AG, PO Box 1227, 8207 Schauffhausen, Switzerland.

d. Additives

Filler (or low profile additive)—Microdol Extra, available from Euroresins UK Ltd., Cloister Way, Bridges Road, Ellesmere Port, Cheshire CH65 4EL, UK. Coathylene HA 1682, available from DuPont.

Catalyst—Perkadox CH-50-X, Triganox 29-B-50 and Triganox C, available from Akzo Nobel

Pigment—Neolite RAL 7001, available from Euroresins UK Ltd, (address as above)

Lubricant—Zinc Stearate available from FACI Spa (UK), Ashcroft Road, Knowsley Industrial Par, Liverpool, L33 7TW, UK.

e. Resin Composition

A thermosettable vinyl ester resin composition was prepared by combining:
80 wt % vinyl ester resin,
16 wt % Microdol Extra filler
1.0 wt % Coathylene HA 1682
1.0 wt % catalyst
0.8 wt % Styrene
0.5 wt % PAT 654/M mould release
0.5 wt % Zinc Stearate
0.2 wt % Neolite RAL 7001 pigment

The components were mixed together and stirred until homogeneous. The mixture was then poured into a resin composition bath.

Test Methods

The following tests were conducted using the basic principles of the standards indicated, but were adapted to suit the nature of the samples being tested:

Pipe Compressive Strength—Based Upon ASTM D2412

Testing was conducted in broad terms in accordance with ASTM apart from the test piece length which was 40 mm. The Strain Rate was 5 mm/min. Three samples of each construction were tested.

Energy at maximum compression was calculated by integrating the area under the curve of load (N) v extension (mm) from the origin to the point of interlaminar failure, and expressing as Joules.

Crash Test According to EN12767

Certified Test

Passively Safe Performance was tested to standard EN12767 by the Transport Research Laboratory, Wokingham, UK. A 5 metre length of post was planted in a 1 metre hole of diameter 300 mm filled with sharp sand compacted every 300 mm. A sign of dimensions 2m tall×1 m wide, weight 18.5 kg, was mounted on the post with the bottom edge 2 m above ground. A Ford Fiesta 1.11 3-door hatchback (1988 model) was adapted for use by adjusting the mass and installing accelerometers in the vehicle. Its gross static mass (938 kg) included ballast adjustment 64 kg to position centre of gravity at 977 mm behind front axle, 451 mm above ground and 5 mm to the right of centre. Thus the vehicle was in compliance with sect. 6.2 of the standard. It was towed by chains attached to continuous loop steel cable attached to a computer controlled hydraulic propulsion system. Just before impact, the chains were detached allowing the vehicle to freewheel into the planted post, the plane of the sign being at an angle of 20 degrees relative to a plane normal to the direction of travel. The performance was tested at 35 km hr⁻¹ and at 100 km hr⁻¹.

Apparatus

A pultrusion apparatus, available as Pultrex P8000 from Pultrex Ltd, The Octagon 27 Middleborough, Colchester, Essex CO1 1PD, UK, was employed.

The apparatus is of a scale able to produce a pipe having an outside diameter of 139.7 mm and a wall thickness of 5.2 mm, or similar sizes by incorporating different sizes of die or mandrel. The resin composite throughput is of the order of 75 kg per hour.

### Examples

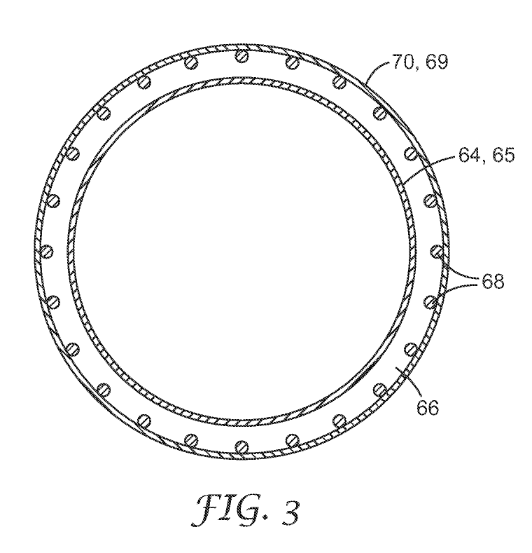

The examples were prepared by pultrusion using the apparatus specified above and the process described earlier. In the construction (FIG. 2), both veils (62,72) were omitted. Otherwise the examples were prepared as in FIG. 2, except where mats (64,65 and /or 70,69) were stated to be omitted. The location of the carbon tows (68) is on the outermost circumference of the longitudinal fiber composite i.e. the third concentric cylindrical array, distributed regularly in bundles. To maintain the volume of the cylindrical layer, where more carbon tows were prescribed, a corresponding number of glass rovings were omitted. An example of this is shown in FIG. 3. Here the arrangement of carbon tows for the example and the comparative examples was, in circumferential sequence, 5 bundles with 2 tows followed by a bundle with 3 tows. This is repeated four times to give 24 bundles regularly distributed about the circumference. FIG. 3 also shows the positions of the inner mat (64,65), the outer mat (70,69) (where present) and the longitudinal glass rovings (66).

In Comparative examples C1-C3, either the inner mat, the outer mat or both were omitted from the pultrusion process described above. Since the mats were quite thin, no adjustment of other components was made to adjust for any volume change due to their omission.

Details of the examples and of the results of testing for Pipe Compressive Strength are provided in Table 1. Details of the Crash Test on example 1 are provided in Table 2.

TABLE 1

| | Longitudinal fibers | | | |
|---|---|---|---|---|
| | Volume % carbon | Weight % Carbon | | Pipe Compressive strength |
| | relative to volume of | relative to weight of | | ASTM D2412 - Energy at |
| | the uni-directional | uni-directional | Mats (inner, outer, | Maximum compression (kJ) |
| Example | layer | tows and rovings | both, none) | Low speed |
| 1 | 10 | 7.57 | both | 5.59 |
| C1 | 10 | 7.57 | Inner only | 0.33 |
| C2 | 10 | 7.57 | Outer only | 3.72 |
| C3 | 10 | 7.57 | none | 0.24 |

TABLE 2
Example 1

| | | | Classification |
|---|---|---|---|
| Nominal impact | Entrance Speed | Exit Speed | and Occupant |
| speed (km hr⁻¹) | (km hr⁻¹) | (km hr⁻¹) | safety level |
| 100 | 98 | 89 | NE 3 |
| 35 | 34 | — | NE 2 |

NE = Non-energy absorbing

1. A tubular support comprising a first composite layer of resin and longitudinal arranged fibers having on each of its opposite major sides a further composite layer comprising resin, transverse fibers at an angle of between 10 and 80° relative to the longitudinal axis of said tubular support and transverse fibers at an angle of between −10 and −80° relative to the longitudinal axis of said tubular support.

2. A tubular support according to claim 1 wherein the total amount of longitudinal arranged fibers is between 50 and 90% by weight based on the total weight of said tubular support.

3. A tubular support according to claim 1 wherein said longitudinal arranged fibers comprises a mixture of first and second fibers, wherein said first and second fibers are different of each other.

4. A tubular support according to claim 3 wherein said first fibers comprise glass fibers and said second fibers comprise carbon fibers.

5. A tubular support according to claim 1 wherein said transverse fibers of said further composite layers comprise glass fibers.

6. A tubular support according to claim 1 wherein said transverse fibers of said further composite layers are provided as a mat.

7. A tubular support according to claim 1 wherein there is further provided between said first composite layer and said further composite layers, a layer of resin and randomly oriented chopped fibers.

8. A tubular support according to claim 7 wherein said chopped fibers comprise glass fibers.

9. A tubular support according to claim 1 wherein said resin of said first composite layer and of said further composite layers comprises a thermoset resin.

10. A tubular support according to claim 1 placed on the side of a road.

11. A tubular support tubular according to claim 1 comprising a sign.

12. Method of making a tubular support as defined in claim 1 comprising (i) providing a tubular arrangement of fibers comprising a layer of longitudinal fibers with on each of its opposite major sides being arranged a layer of transverse fibers at an angle of between 10 and 80° relative to the longitudinal axis of the tubular arrangement of fibers and transverse fibers at an angle of between −10 and −80° relative to the longitudinal axis of the tubular arrangement of fibers, (ii) impregnating the tubular fiber arrangement with resin and (iii) pulling the tubular fiber arrangement through a die to provide a desired shape to the tubular support.
